(19) United States
(12) Patent Application Publication
(10) Pub. No.: US 2013/0072226 A1
(43) Pub. Date: Mar. 21, 2013

(54) Systems and Methods for Tracking Mobile Devices

(71) Applicant: Jeff Thramann, Longmont, CO (US)

(72) Inventor: Jeff Thramann, Longmont, CO (US)

(21) Appl. No.: 13/624,428

(22) Filed: Sep. 21, 2012

Related U.S. Application Data
(60) Provisional application No. 61/537,412, filed on Sep. 21, 2011.
(60) Provisional application No. 61/621,250, filed on Apr. 6, 2012.

(51) Int. Cl. H04W 24/00

(52) U.S. Cl. 455/456.1

(57) ABSTRACT

The present application provides for mobile, wireless devices to be tracked passively using triangulation (via cellular towers or solar canopies as explained in some of the related applications identified above and expressly incorporated herein by reference) to provide information to a service regarding when a client device accesses the area. When the client device enters an identified location, which may be designated by a geo-fence, an activation signal is transmitted to the mobile, wireless device to activate a global positioning location module, which provides more accurate position information. The mobile, wireless device may be registered as being located at the identified location.

### CLAIM OF PRIORITY UNDER 35 U.S.C. §119

The present application claims priority to U.S. Provisional Patent Application Ser. No. 61/537,412, titled Systems and Methods for Tracking Mobile Devices, filed Sep. 21, 2011, and U.S. Provisional Patent Application Ser. No. 61/621,250, titled the same, filed Apr. 6, 2012, both of which are incorporated herein by reference as if set out in full.

### CLAIM OF PRIORITY UNDER 35 U.S.C. §120

None.

### REFERENCE TO CO-PENDING APPLICATIONS FOR PATENT

The present application for patent is related to co-Pending U.S. Provisional Patent Application Ser. No. 61/537,319, titled Electric Vehicle Charging Station with Connectivity to Mobile Devices to Provide Local Information, filed Sep. 21, 2011; U.S. Provisional Patent Application Ser. No. 61/537,346 titled Electric Vehicle Charging Station Adapted for the Delivery of Goods and Services, filed Sep. 21, 2011; U.S. Provisional Patent Application Ser. No. 61/608,425, titled Electric Vehicle Charging Station with Connectivity to Mobile Devices to Provide Local Information, filed Mar. 8, 2012; U.S. Provisional Patent Application Ser. No. 61/608,439, titled Electric Vehicle Charging Station Adapted for the Delivery of Goods and Services, filed Mar. 8, 2012, all of which are incorporated herein by reference as if set out in full.

### BACKGROUND

1. Field

The technology of the present application relates generally to tracking a global positioning system (GPS) enabled device and, more particularly, to methods and systems to passively track a device with a radio frequency transceiver and enabling the GPS or other applications, when it is determined, that the passively tracked device enters a predefined geo-fence.

2. Background

Mobile internet enabled devices are becoming more and more ubiquitous in today's society. One popular embodiment of a mobile internet enabled device is a cellular telephone capable of connecting to the internet (also known as a “Smartphone”) through any of a cellular network, such as, for example, the so-called 4G network, a Wireless Fidelity (WiFi) connection, a Bluetooth connection, a HomeRF connection, or the like. As these devices become more common place, society has a need to locate others similarly connected and of common interest.

To satisfy the need to be “connected” to others, many social media services, such as, for example, Facebook, Twitter, Linkedin, Plaxco, and the like, have become increasingly popular. One of the currently more popular social media services is commonly known as FACEBOOK®, available at www.facebook.com, from Facebook, Inc. located in Palo Alto, Calif. The users of FACEBOOK® typically create personal profiles and link or connect their profile pages to their friends' pages; friends should be interpreted broadly as people accepted into the user's network on the social media service, sometimes more generically referred to as colleagues. The users of FACEBOOK® in part use the social media service to send messages to colleagues, alert colleagues to on-going activities, and inform colleagues of their plans or whereabouts.

Other services allow more direct communication of a user's whereabouts. One popular service is generally known as Foursquare located in New York, N.Y. Foursquare, unlike Facebook, is a location-based social networking service based on hardware and software on a mobile device, such as, for example, a GPS enabled Smartphone. Generally, the Foursquare service allows users to arrive at a location or an establishment and “check-in” on the service using a device-specific application running on the smartphone. The GPS confirms the location of the user at the establishment and the user is rewarded for using the service. The rewards may include points, titles, gift certificates, discounts, or the like at the location or establishment.

Users can choose to have their “check-ins” posted on their foursquare account, or other social medial services, such as Facebook, Twitter, a combination, or the like. The posts are pushed to linked friends or colleagues. Thus, for example, if a user is eating lunch at Old Ebbit Grill located at 675 15th Street, Northwest, Washington, D.C., the user can check-in using the location-based social networking service. The service pushes the information to colleagues that may elect to join the user if they are in the vicinity or the like.

While one benefit of checking in is allowing colleagues to follow and/or join your party, another benefit may be awards, discounts, or the like. For example, foursquare provides “BADGES”, “MAYORSHIPs”, and “STATUS”, or the like. Badges are earned, for example, by completing tasks, such as checking in at certain venues in a certain location, such as, for example, the CHOPHOUSE in Houston, Tex. Mayorships may be earned by being the user with the most “check ins” at a particular location, such as, at the aforementioned Old Ebbit Grill. As the “Mayor” of an establishment, the user may be entitled to discounts, coupons, a special meal, a gift, a visit by the owner, chef, personality, or the like.

However, the aforementioned services, location based or not, require the user to actively update the information. Thus, against this background, there is a need to provide an improved method to update information to social media services, such as Facebook and Foursquare, without requiring action by the user.

### SUMMARY

This Summary is provided to introduce a selection of concepts in a simplified and incomplete manner highlighting some of the aspects further described in the Detailed Description. This Summary, and the foregoing Background, is not intended to identify key aspects or essential aspects of the claimed subject matter. Moreover, this Summary is not intended for use as an aid in determining the scope of the claimed subject matter.

In certain aspects of the technology of the present application, geo-fences may be established with respect to areas. The client devices may be tracked passively using triangulation (via cellular towers or solar canopies as explained in some of the related applications identified above and expressly incorporated herein by reference) to provide information to a service regarding when a client device accesses the area. When the client device enters the geo-fenced area, an application can send a signal activating a global positioning system to better track the individual for more honed local establishment information as described above. In certain aspects of the technology of the present application, on entering a geo-fenced area, the client device and user are registered at that area on a service.

Alternatively to tracking the individual by a GPS, wireless connectivity points for the Smartphones may be used to triangulate the location. For example, a number of WiFi hotspots may be used to triangulate the location of the Smartphone.

These and other aspects of the technology of the present application will be apparent after consideration of the Detailed Description and Figures herein. It is to be understood, however, that the scope of the application shall be determined by the claims as issued and not by whether given subject matter addresses any or all issues noted in the Background or includes any features or aspects highlighted in this Summary.

### BRIEF DESCRIPTION OF THE DRAWINGS

FIG. 1 is a functional block diagram of a system consistent with the technology of the present application;

FIG. 2 is a methodology associated with using the technology of the present application;

FIG. 3 is a functional block diagram of a system consistent with the technology of the present application; and

FIG. 4 is a methodology associated with using the technology of the present application; and

FIG. 5 is a functional block diagram of a system consistent with the technology of the present application.

### DETAILED DESCRIPTION

The technology of the present patent application will now be explained with reference to various figures, tables, and the like. While the technology of the present application is described with respect to using global positioning system (GPS) enabled cellular telephones that have Internet connectivity (e.g., Smartphones with GPS), the technology should not be limited to the same. In particular, one of ordinary skill in the art would now recognize that the technology is applicable to other devices that may be interconnected with a GPS device or interconnected with Internet connectivity. Additionally, instead of using GPS to locate a particular Smartphone, alternative methods of tracking cellular telephones may be used including triangulation from cellular towers, WiFi connections, Bluetooth connections, or other radio frequency band connectivity devices such as microcells or the like. Moreover, the technology of the present patent application will be described with reference to certain exemplary embodiments herein. The word “exemplary” is used herein to mean “serving as an example, instance, or illustration.” Any embodiment described herein as “exemplary” is not necessarily to be construed as preferred or advantageous over other embodiments absent a specific indication that such an embodiment is preferred or advantageous over other embodiments. Moreover, in certain instances, only a single “exemplary” embodiment is provided. A single example is not necessarily to be construed as the only embodiment. The detailed description includes specific details for the purpose of providing a thorough understanding of the technology of the present patent application. However, on reading the disclosure, it will be apparent to those skilled in the art that the technology of the present patent application may be practiced with or without these specific details. In some descriptions herein, generally understood structures and devices may be shown in block diagrams to aid in understanding the technology of the present patent application without obscuring the technology herein. In certain instances and examples herein, the term “coupled” or “in communication with” means connected using either a direct link or indirect data link as is generally understood in the art. Moreover, the connections may be wired or wireless, private or public networks, or the like.

Very accurate location information is available for devices having GPS, however, operating the GPS location module in mobile devices (generally referred to as GPS) requires significant power and energy from the battery. Given the limited supply of energy for most mobile devices due to the limitations on batteries, it would be difficult to use the GPS to locate a device in a continuous real-time basis absent the ability to recharge the battery, which diminishes the usefulness of both the GPS and the device. Thus, it would be desirous to provide location specific information about the device without the need for powering the GPS except when additional accuracy is required or desired.

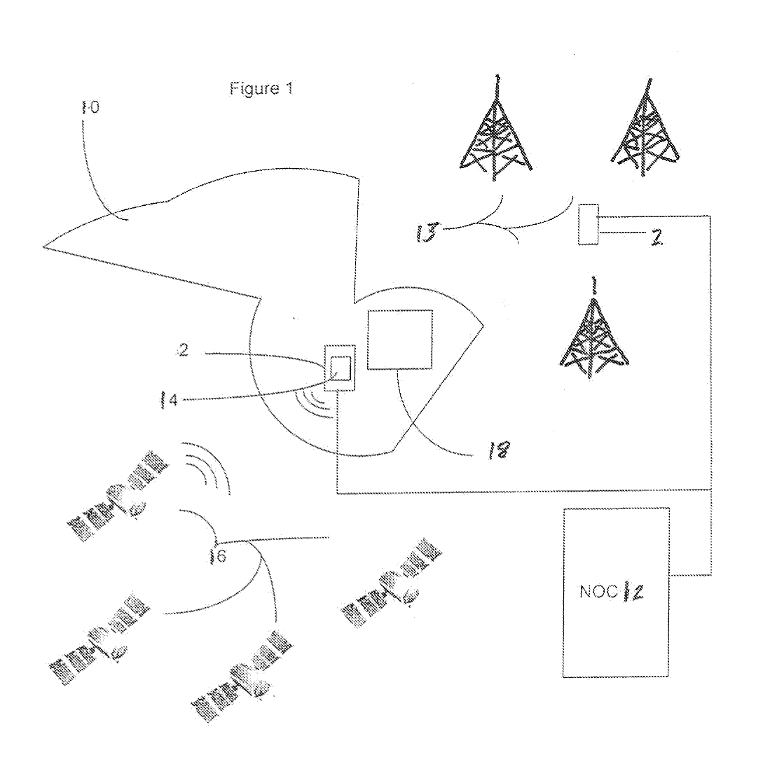

Referring first to FIG. 1, it may be possible to provide more location specific information on an as needed basis while using less power intensive location information during normal operations. The low power tracking sometimes may be referred to as passively tracking the mobile device. For example, using the technology of the present application, it is possible to obtain tracking measures to determine the real time or near real time location of one or more client devices 2 in a particular area and transmit, for example, a Starbucks® coffee coupon to the client device as the client is walking past or into the coffee shop. With specific regards to FIG. 1, a geo-fence 10 may be established in which local merchants, shops, etc. may be registered. In this exemplary embodiment, the geo-fence 10 is a random shape. The shape, however, may be regular, such as a polygon or elliptical shape, or random as shown. For example, in certain embodiments, the geo-fence 10 may be established around a mall, a city block(s), a particular establishment, or the like. The geo-fence boundary may be programmed by a coordinate system such as using, for example, the World Geodetic System (“WGS84”), the last rendition of which was in 1984. The client would register the client device 2 with a centralized network operations center 12, which may be one or more servers, computers, chip-sets, or the like. Using various passive tracking mechanisms currently available, such as, for example, triangulation via cellular towers 13 connection and signal strength, the network operations center 12 can determine the approximate location of the client device 2 relative to certain cellular tower signals. The position of the cellular towers is referenced to the coordinate system, such as the WGS84. Thus, the relative position of the client device may be superimposed onto the coordinate system. At predetermined times, continuously, or random times, the network operations center 12 would determine the position of the client device 2 using one of the passive tracking mechanisms, which are typically accurate to approximately 100 meters. The network operations center 12 would compare the location of the client device 2 to the geo-fenced area to determine whether the client device 2 is in a geo-fenced area 10. The client device 2 is shown in two separate positions in FIG. 1; one inside the geo-fence 10 and one outside the geo-fence 10. Due to accuracy, the geo-fenced area 10 may be overlarge and/or the position of the client device 2 within a certain distance of the geo-fence area 10 may be sufficient to trigger the application as explained further below. Once it is determined the client device 2 is in a geo-fenced area 10, the network operations center 12 would send a signal to activate a global positioning system 14 on the client device 2. The GPS 14 would coordinate with overhead satellites 16 to triangulate the specific position of the client device 2 with an accuracy of less than a meter in many applications. The specific location of client device 2 can be coordinated within the geo-fenced area 10 by the network operations center 12. Alternatively, if solar canopies with transceivers, as explained in co-pending related applications identified above, which are incorporated herein by reference are deployed about the area 10, and the client device 2 has connectivity with a transceiver in the solar canopy, then the tracking may be coordinated by triangulating the client device 2 with the locally based known positions of the solar canopies. Tracking with a plurality of deployed location known, devices may be beneficial in indoor or other areas where satellite coverage is unavailable or spotty. Other similarly known positions, such as, for example, micro-cells, WiFi hotspots, or the like may similarly be used. WiFi hotspots, while useful, are not preferable for the technology of the present application in view of their limited ability to penetrate walls and distance. One radio frequency band that is promising for locating a wireless device using radio frequency triangulation is the use of the white space in the television spectrum. The white space in the television band is useful as it is unlicensed space between transmission channels that is unused and has good distance and penetration ability, unlike the current WiFi bands. Certain mobile devices may need modified or additional radio frequency transceivers for operation in this particular band. This tracking mechanism could use conventional triangulation and location determination methods and algorithms, but should have a better accuracy than triangulation using cellular towers 13 as the solar canopies using the white space frequency or WiFi, or micro-cells are located in relatively close proximity. While the tracking likely would not be as accurate as a GPS transceiver, the tracking may be sufficiently accurate to justify the reduced battery draw of the GPS transceivers. Also, using the solar canopies and/or micro-cells for more accurate triangulation would allow devices without GPS transceivers to use the technology herein.

In operation, merchants 18 would similarly register with the network operations center 12. Each merchant 18 would provide the specific coordinates to the network operations center 12 such that the merchant 18 may be located within the geo-fenced area 10. Once activated, the network operations center 12 using the GPS 14 would track the client device 2 in real or near real time. The actual location would be compared to the merchant 18 coordinates to determine whether the client device 2 is within a predetermined distance of a local establishment. The predetermined distance may be as little as less than 1 meter to as much as about 10 meters; although, other distances are possible. Once within a determined distance of the merchant 18, the network operations center 12 would determine whether the merchant 18 has any available advertisements, coupons, texts, or the like available for delivery to the client via the client device 2. The network operations center 12 would deliver the advertisement through the communication link to the client device. This would allow detailed transmission of location specific information to the client to enhance the probability that the client would receive the information and act on the same due to the timeliness and location specific receipt of the information.

The above geo-fencing application may be beneficial to many existing applications that currently operate for social networking and other purposes. For example, as explained above, certain smartphone applications allow users to “check-in” at particular venues. The smartphone is configured to upload its location to a website that may alert “friends” or associates of the user's location and other local establishments. In many applications, the users must be both at the establishment and manually invoke the application or execute the application such that the system “checks in” the user. Using the present technology, however, it would be possible to activate a geo-fence associated with the establishment such that when a user first checks into a particular location, the geo-fence is activated for that user. The system, as described above, would passively track the user and, on entering the geo-fenced area, automatically check the user into the establishment. The application would also be automatically invoked on the smartphone by the service once the location of the user has been determined. Establishment of the geo-fence may be accomplished by registering the establishment, similar to as described above, or the geo-fence may be established automatically by the service when a user checks in at a particular place. For pre-registered establishments, the automatic check-in feature would function the first time a user enters the geo-fenced area. For other establishments, the users would need to manually check in at an establishment the first time. The GPS (or other tracking device if not GPS) would identify the location of the user and coordinate the specific location with an address, using any of a plurality of on-line available mapping systems, such as Google maps, Map-Quest, etc. The map would be coordinated with a coordinate system to establish the boundaries of the address (or at least the entry and exit points) such that a geo-fence may be established for the establishment such that the next time a user enters the establishment, such as a friend joining the original user, the geo-fence would be established and the friend's device 432 would be automatically checked into the establishment.

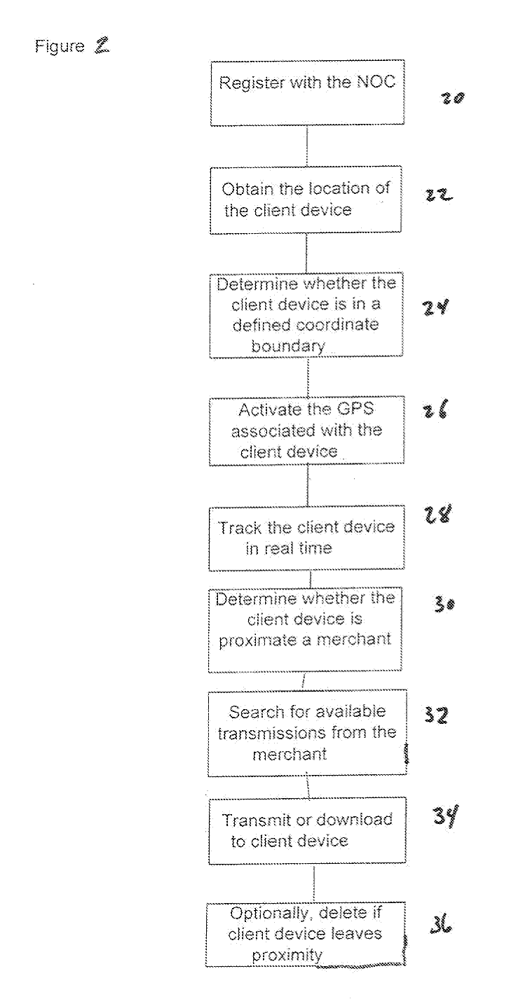

Referring next to FIG. 2, a method of implementing the technology described with respect to FIG. 1 that is consistent with the present application is provided. In a first step 20, the client would register the client device, such as client device 2, with a network operations center 12. This would provide the network operations center 12 with permission to track the client, which may be required in certain jurisdictions in regards to privacy laws. The network operations center 12 would, in the normal course, receive and/or calculate the location of the client device 2, step 22. Often the client device 2 uses information from the cellular network to identify its location. In some cases, the client device 2 coordinates with a location-based service (LBS) to determine the location. Thus, network operations center 12 may incorporate a LBS or may receive the coordinates of the client device 2 over the network. In any event, the network operations center 12 obtains the coordinates of the client device. At step 24, the network operations center 12 would next determine if the coordinates of the client device 2 are located in (or within a predetermined distance) of a geo-fenced (or some other identified coordinate system). If the network operations center 12 (which may, in fact, be contained in the client device 2 itself) determines the client device 2 is in a geo-fenced area, the GPS associated with client device 2 is activated, step 26. Alternatively, the GPS may be continually on; however, this is not a desirable solution as the GPS transmitter consumes a large amount of energy that drains the mobile device battery quickly. Once the GPS is activated, the network operations center 12 tracks the client device 2 based on the coordinate system in real time or near real time, step 28. Substantially, at the same time that the network operations center 12 is tracking the client device, it is determining the proximity of the client device 2 to one or more merchants 18, step 30. When the proximity of the client device 2 to one of the merchants 18 is within a certain range, the network operations center 12 searches the advertisements available for the merchants, step 32, and transmits/downloads the advertisement to the client device 2, step 34. Alternatively, as described above, the device 2 may activate a check-in when determined to be within the proper proximity of the geo-fence, which may have a time on location requirement as well. The client using client device 2 may be notified of the transmission/download as appropriate. The transmission/download may be a HTML download, a SMS message, a voice message, a call, an email, or the like. Optionally, the provided advertisement (or check-in) may be deleted automatically if the file is not accessed prior to the client device 2 exiting the proximity area and/or not sufficient time on location, step 36. The proximity area for receiving the download may be a first range, and the proximity area for automatic deletion of the download may be a second range.

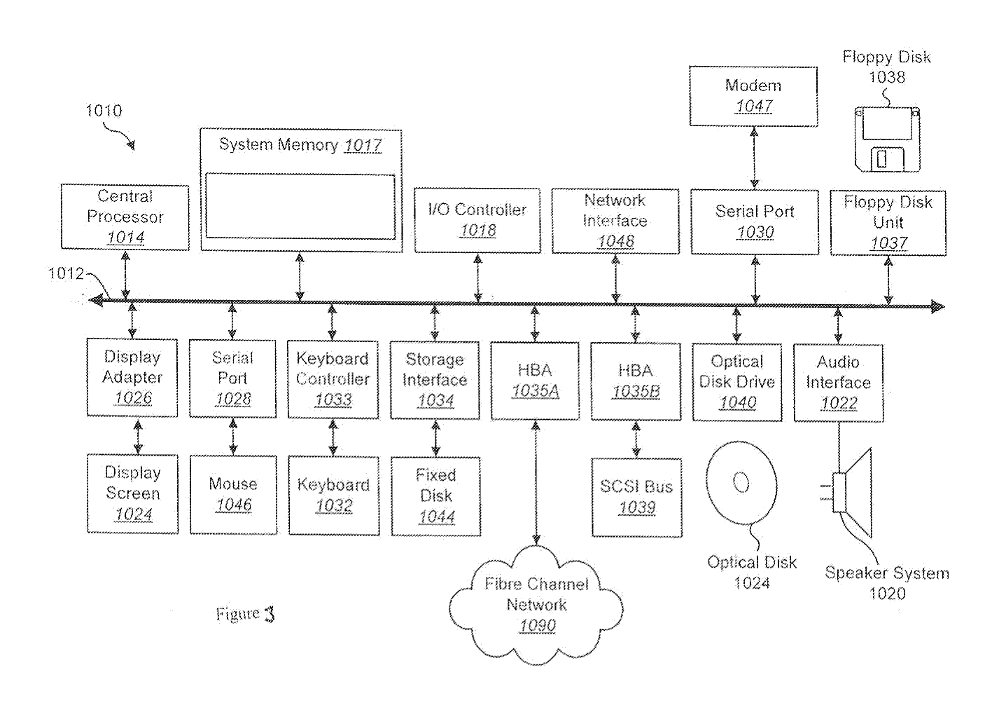

FIG. 3 depicts a block diagram of a computer system 1010 suitable for implementing the present systems and methods. Computer system 1010 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), multiple USB devices 1092 (interfaced with a USB controller 1090), a storage interface 1034, a floppy disk drive 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other codes, the Basic Input-Output system (BIOS) which controls basic hardware operation such as the interaction with peripheral components or devices. For example, the gifting module 104 to implement the present systems and methods may be stored within the system memory 1017. Applications resident with computer system 1010 are generally stored on and accessed via a computer readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 1010, can connect to a standard computer readable medium for storage and/or retrieval of information, such as a fixed disk drive 1044. Fixed disk drive 1044 may be a part of computer system 1010 or may be separate and accessed through other interface systems. Modem 1047 may provide a direct connection to a remote server via a telephone link or to the Internet via an Internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 3 need not be present to practice the present systems and methods. The devices and subsystems can be interconnected in different ways from that shown in FIG. 3. The operation of a computer system, such as that shown in FIG. 3, is readily known in the art and is not discussed in detail in this application. Code to implement the present disclosure can be stored in a computer-readable medium such as one or more of system memory 1017, fixed disk 1044, optical disk 1042, or floppy disk 1038. The operating system provided on computer system 1010 may be MS-DOS®, MS-WINDOWS®, OS/2®, UNIX®, Linux®, or another known operating system.

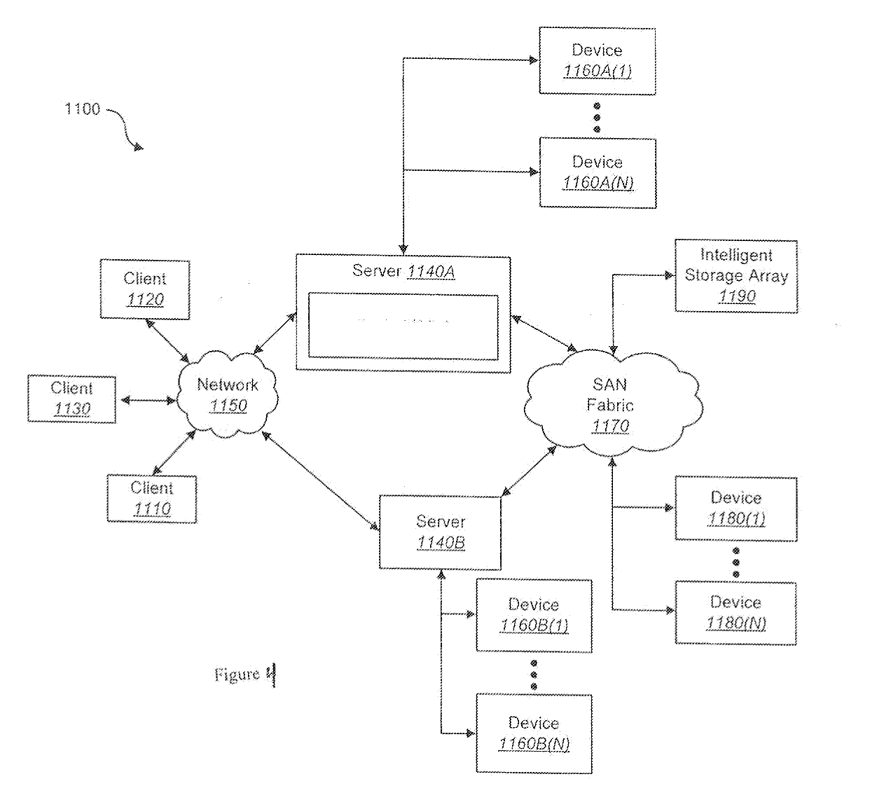

FIG. 4 is a block diagram depicting a network architecture 1100 in which client systems 1110, 1120 and 1130, as well as storage servers 1140A and 1140B (any of which can be implemented using computer system 1110), are coupled to a network 1150. In one embodiment, the gifting module 104 may be located within a server 1140A, 1140B to implement the present systems and methods. The storage server 1140A is further depicted as having storage devices 1160A(1)-(N) directly attached, and storage server 11408 is depicted with storage devices 1160B(1)-(N) directly attached. SAN fabric 1170 supports access to storage devices 1180(1)-(N) by storage servers 1140A and 1140B, and so by client systems 1110, 1120 and 1130 via network 1150. Intelligent storage array 1190 is also shown as an example of a specific storage device accessible via SAN fabric 1170.

With reference to computer system 1010, modem 1047, network interface 1048 or some other method can be used to provide connectivity from each of client computer systems 1110, 1120, and 1130 to network 1150. Client systems 1110, 1120, and 1130 are able to access information on storage server 1140A or 11408 using, for example, a web browser or other client software (not shown). Such a client allows client systems 1110, 1120, and 1130 to access data hosted by storage server 1140A or 11408 or one of storage devices 1160A(1)-(N), 1160B(1)-(N), 1180(1)-(N) or intelligent storage array 1190. FIG. 4 depicts the use of a network, such as the Internet, for exchanging data, but the present systems and methods are not limited to the Internet or any particular network-based environment.

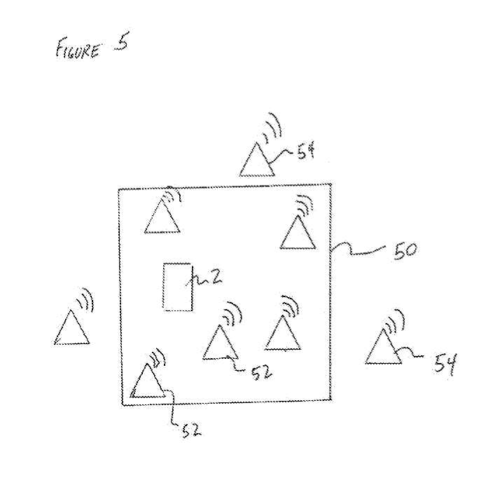

As mentioned above, one option for tracking and locating a wireless or mobile device in a location is to track the device using GPS. Alternatively, connectivity to multiple radio frequency, non-GPS, devices may provide the ability to triangulate the location of the client device 2. For example, with reference to FIG. 5, a location 50 may have multiple wireless access points 52, 54 generically known as hotspots. As shown, the hotspots 52 may be inside the location 50 or the hotspots 54 may be outside the location 50. Most of the hotspots 52, 54 are generic WiFi transceivers operating in 2.4 GHz to 5 GHz range, otherwise known as the junk band. Generally, the junk band is a crowded, relatively low power and penetration signal making it ineffectual for many applications. In some crowded areas, such as, for example, a walking mall, a sufficient number of WiFi devices with known geodetic coordinates exist such that the location of a particular cellular device may be located via triangulation. Rather than using GPS, the WiFi tracking, when available, may replace the positional location of the client device such that the NOC 12 will download or push information to the client device. In some situations, the client device may be able to download a map of the location to find registered establishments. For example, if such a system was functioning on the Washington D.C. mall, a user of client device 2 may access an application to provide a map of the mall that would provide an icon or other indicia of where on the map the client device 2 is located. Moreover, a search feature may be used to find, for example, directions to the museum of natural history, or the like. Similarly, for shopping malls, a similar map may show locations for stores, restaurants, or the like in relation to the client device 2. If conductivity to a sufficient number of hotspots exists, levels or elevations may be available as well. Using generic WiFi transceivers as hotspots 52, which are usable by most mobile devices, presents difficulties as the signals frequently are not overly robust. In other words, even with a large cluster of hotspots 52, it is likely the location will still have numerous no-signal zones; otherwise known as dead zones. Alternatively, micro-cells may be used instead of WiFi access points for hotspots 52. Under certain standards, however, micro-cells require the ability to be located using GPS technology. External hotspots 54 may be conventional cellular towers arranged in relatively close proximity to facilitate triangulation of device 2. As mentioned above, the white space between radio/broadcasting bands may be used for mobile devices being able to receive/send signals in this band. The white space radio frequency band is in the 50 MHz to 700 MHz frequency. Currently, not all mobile devices are capable of operation in this band, and devices may require a retrofit to allow for tracking. A location transmitter/receiver may be installed on the solar canopies associated with the related applications incorporated herein by reference or other structures around existing facilities. Given the ability of these signals to travel and penetrate into buildings, fewer devices may be required to provide the required number of points for triangulation of client device 2. Also, structures as described could be erected external to the location of concern.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

I claim:

1. A method to determine whether a mobile, global positioning system (GPS) enabled device is within a predetermined distance of a location, comprising the steps of:
providing an account comprising an identification of a mobile, global positioning system (GPS) enabled device with a service;
locating an establishment on a coordinate system;
establishing a boundary around the establishment located on the coordinate system;
receiving information identifying the location of the mobile, GPS enabled device;
determining whether the mobile, GPS enabled device is within the boundary established about the establishment;
if it is determined that the mobile, GPS enabled device is within the boundary established about the establishment, transmitting a signal to the mobile, GPS enabled device to activate a GPS location module;
receiving a position of the mobile, GPS enabled device from the GPS location module; and
identifying the position of the mobile, GPS enabled device about the boundary area.

2. The method of claim 1 wherein the step of establishing a boundary around the establishment comprises establishing a geo-fence.

3. The method of claim 1 wherein the step of locating the establishment comprises locating a plurality of establishments.

4. The method of claim 1 further comprising the step of determining the proximity of the mobile, GPS enabled device to the establishment using the position from the GPS location module and transmitting information about the establishment to the mobile, GPS enabled device.

5. The method of claim 4 wherein the information transmitted includes at least one of an advertisement or a coupon.

6. The method of claim 3 wherein the plurality of establishments comprise a mall.

7. The method of claim 1 further comprising the steps of:
determining whether the mobile, GPS enabled device has entered the establishment using the position from the GPS location module; and
updating information with a social media service that the mobile, GPS enabled device has entered the establishment.

8. The method of claim 7 wherein the steps of locating an establishment on a coordinate system and establishing a boundary around the establishment automatically occur when the mobile, GPS enabled device has entered the establishment.

9. The method of claim 1 wherein the GPS location module uses location-based services to determine the position of the mobile, GPS enabled device.

10. A method to determine whether a mobile, global positioning system (GPS) enabled device is within a predetermined distance of a location, comprising the steps of:
receiving from a plurality of wireless transmitters proximate an area having a boundary known location information for each of the plurality of wireless transmitters;
determining a signal strength of a wireless device in communication with at least one of the plurality of wireless transmitters proximate the area;
tracking a position of the wireless device within the area based on the signal strength between the wireless device and the at least one of the plurality of wireless transmitters;
identifying when the wireless device within the area is in proximity to a merchant located in the area; and
transmitting merchant data to the wireless device.

11. The method of claim 10 wherein the plurality of wireless transmitters operate in the white space radio frequency band.

12. The method of claim 10 wherein the merchant data transmitted comprises a map from the wireless device to the merchant.

13. The method of claim 12 wherein the map is updated in real time as the position of the wireless device is tracked.

14. The method of claim 10 wherein the merchant data includes transmitting a coupon.

15. The method of claim 14 wherein the coupon expires after a predetermined amount of time.

16. A network operation center for identifying a location of a registered mobile device, the network operation center comprising:
a receiver module, the receiver module to receive data about a registered mobile device;
a locator module, the locator module to use the data about the registered mobile device to determine a location of the registered mobile device;
a geo-fence module, the geo-fence module to establish a geo-fence boundary around an area;
a determinator module, the determinator module to determine whether the mobile device location is in the geo-fence boundary area;
a global positioning system (GPS) trigger module, the GPS trigger module to transmit a signal to the mobile device to activate a GPS location module in the mobile device; and
a GPS module, the GPS module to receive position data from the GPS module in the mobile device.

17. The network operation center further comprising location based services to calculate a position of the mobile device based on the received position data from the GPS module in the mobile device.

18. The network operation center further comprising an advertisement module, the advertisement module to transmit advertisements to the mobile device based on the position of the mobile device.

19. The network operation center further comprising a social feed module to automatically update a status of a social media network based on the position of the registered mobile device.
